(19) United States
(12) Patent Application Publication
(10) Pub. No.: US 2026/0230026 A1
(43) Pub. Date: Aug. 6, 2026

(54) TRUSS BASED PANEL SUPPORT

(71) Applicant: DS2.0, LLC, Portland, TN (US)

(72) Inventors: Dean Solon, Gallatin, TN (US); Itai Suez, Castalian Springs, TN (US)

(21) Appl. No.: 19/468,927

(22) Filed: Feb. 3, 2026

Related U.S. Application Data
(60) Provisional application No. 63/753,273, filed on Feb. 3, 2025.

(51) Int. Cl. H02S 20/10

(52) U.S. Cl. CPC H02S 20/10

(57) ABSTRACT

This disclosure describes solutions for mounting photovoltaic solar panels to a racking/mounting tube. This can include a frame configured to be affixed to an edge of a photovoltaic panel; a bracket mounted to a surface of the photovoltaic panel, the bracket comprising a locking mechanism configured to interface with a surface feature; and two or more tension members extending from the frame to the bracket configured to place the photovoltaic panel in compression.

### CROSS-REFERENCE TO RELATED APPLICATION

This application claims priority to U.S. Provisional Application No. 63/753,273, filed on February 3, 2025. The disclosure of the prior application is considered part of and is incorporated by reference in the disclosure of this application.

### BACKGROUND

Solar arrays made up of multiple photovoltaic modules (referred to as “panels” for brevity) are often installed in a series electrical string configuration. Ground-mounted photovoltaic solar panel arrays are often installed on racking systems using pile foundations. The panels in the array can be configured to tilt in order to track the sun and increase the electrical power generated by the solar panels. This solar tracking can be implemented using a shaft or series of coupled shafts that rotate the panels.

### SUMMARY

The present disclosure involves methods, systems, and an apparatus for mounting photovoltaic solar panels to a mounting tube. This can include a frame configured to be affixed to an edge of a photovoltaic panel; a bracket mounted to a surface of the photovoltaic panel, the bracket comprising a locking mechanism configured to interface with a surface feature; and two or more tension members extending from the frame to the bracket configured to place the photovoltaic panel in compression.

Implementations can optionally include one or more of the following features.

In some instances, the surface feature is a surface feature on a mounting/torque tube, and wherein when interfaced, the bracket couples the photovoltaic panel to the torque tube.

In some instances, the bracket forms an electrical connection between an output of the photovoltaic panel and a conductor mounted to the torque tube.

In some instances, the bracket is mounted to the surface of the photovoltaic panel using an adhesive.

In some instances, the frame is friction fit to the edge of the photovoltaic panel.

In some instances, the two or more tension members are steel cables.

In some instances, the two or more tension members are tensioned to a predetermined tension. In some implementations, that puts the panel in a pre-loaded stress opposing the forces/loads from the frontside of the panel.

The subject matter discussed herein can provide one or more of the following advantages. The disclosed system can provide better panel reinforcement and therefore stronger panels with similar or higher load ratings using less costly material. That is, the array can be more resilient to weather, earthquake, mishandling, or other factors while costing less than conventional framing/structural methods. Additionally, the majority of the support structure can be prefabricated and installed. Therefore, field installation of panels, which often occurs exposed to adverse environmental conditions, can be faster, require less skill, and safer.

The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 depicts an example system with a solar array mounted to tracking torque tubes.

FIG. 2 illustrates a side, exploded view of a truss mounting system.

FIG. 3 illustrates a side, assembled view of a truss mounting system.

FIG. 4 illustrates a side, assembled view of a truss mounting system with an alternate bracket.

FIG. 5 illustrates example alternative torque tube configurations.

### DETAILED DESCRIPTION

This disclosure describes implementations for a mounting system that uses tension members such as cables or rods under tension to apply compressive force to the rear face of a solar panel (stated alternatively, a tensile stress on the front face of a solar panel) in order to reinforce the panel from forces or loading such as natural forces/loading on the front face of the glass, while reducing the amount of structural materials required. Additionally, because all of the structural support material can be pre-installed on the panel, field installation of the panel to the mounting/tracking tube can be greatly simplified. For example, a bracket can be configured to index and couple with a surface feature of the mounting/tracking tube, allowing installers to simply “click” the panel and support structure onto the tube without performing field assembly of the panel mounting hardware.

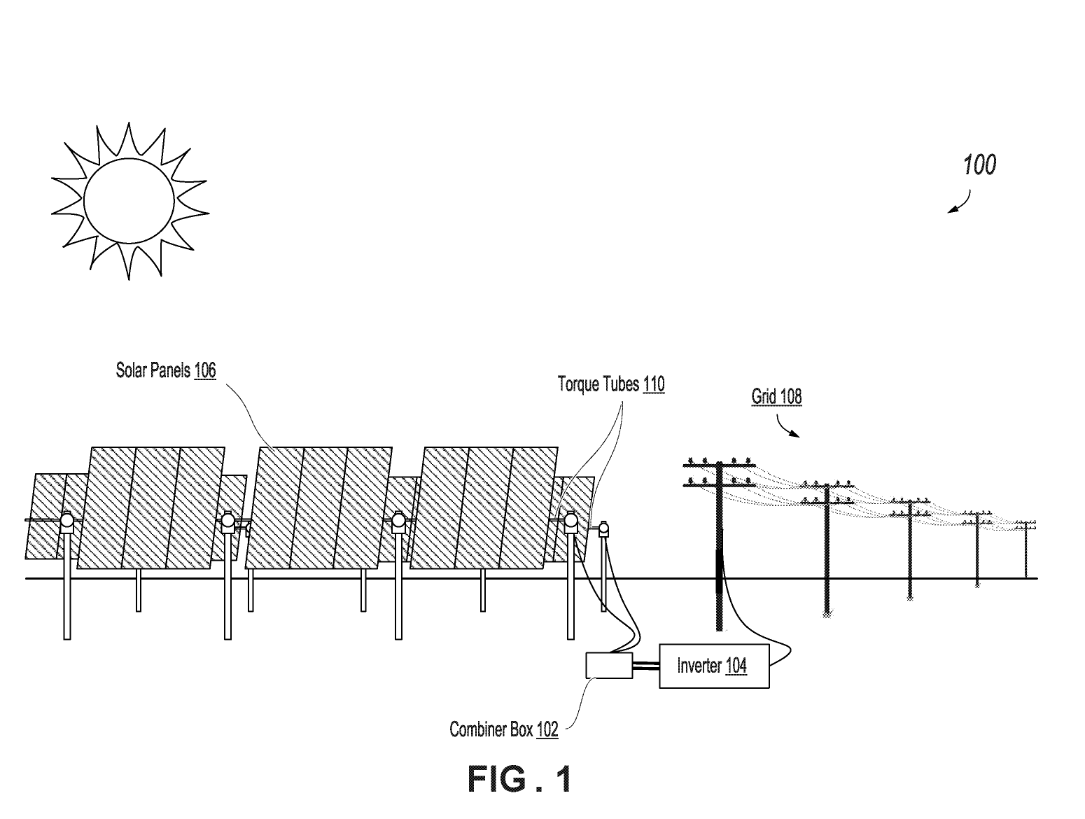

FIG. 1 depicts an example system 100 with a solar array mounted to tracking torque tubes. In the illustrated system 100, the combiner box 102 is supplied from an array of solar panels 106. While two strings are illustrated, more or fewer strings is possible. The combiner box 102 combines several outputs (e.g., 2, 4, 12, 24, etc.) from the solar panels 106 into a single DC output that is provided to the inverter 104. The inverter 104 converts the DC output of the combiner box 102 into alternating current (AC) power, which in the illustrated example, is supplied to the grid 108.

In some implementations, instead of an inverter 104 and/or grid 108, other applications are possible. For example, the solar panels 106 can be connected to a combiner box 102 which supplies a battery, DC motor, home or building inverter, or other components (not shown).

Each solar panel 106 can be mounted to a torque tube 110, which is rotated by a tracking motor to angle the panels 106 toward the sun to improve power generation. Because the solar panels 106 must rotate as the torque tubes 110 rotate, they are supported exclusively from the torque tubes 110, providing a relatively small area on which to support a relatively large panel.

In conventional systems, the panels 106 are mounted to the torque tubes using mounting brackets that include rigid support members mounted directly to the frame of the panel. However, the traditional rigid mounting hardware can be an expensive part of installation that uses a lot of material (e.g., aluminum or steel) and is labor intensive to install. Therefore, to minimize material required, and labor to install, conventional systems are as small as possible while still maintaining a minimum structural integrity. To overcome those shortcomings, the present specification discloses a new truss-based panel support/mounting system. As discussed in more detail below, the new mounting system includes frame members that are configured to engage edges of a photovoltaic panel, a bracket that is configured to be secured to the torque tube and a face of the panel (e.g., a surface between edges of the panel), and truss members that are configured to connect to each of the frame members and the bracket. This new system provides advantages over conventional mounting hardware, for example because the tensioned truss members can create an internal stress in the panel which opposes the natural forces/loading from the front face of the panel, and pre-load the frame/bracket accordingly. This enables an overall stronger system for less material. Additionally, the system can be pre-assembled and configured to have a bracket that “snaps” or “clicks” to a mounting/torque tube, enabling rapid and low cost installation.

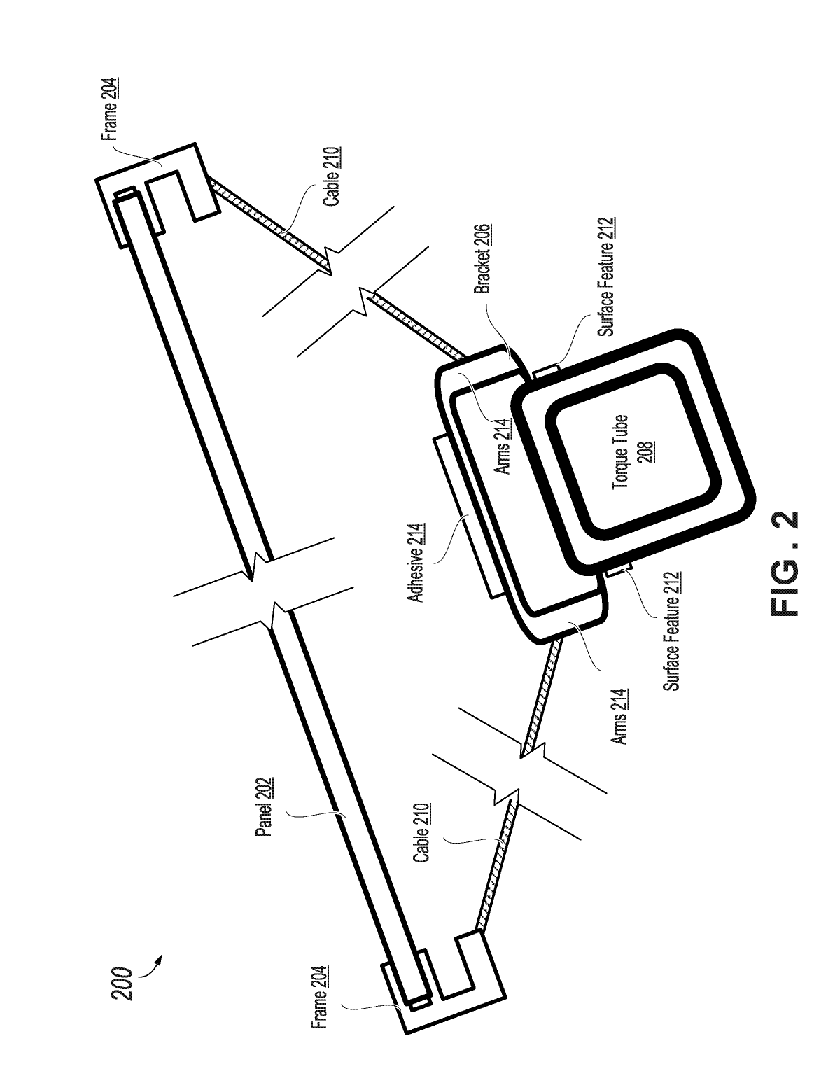

FIG. 2 illustrates a side, exploded view of a truss mounting system 200. The system includes a panel 202, frames 204, bracket 206, torque tube 208, cables 210, and surface features 212.

The panel 202 can be a photovoltaic panel that can be a device to convert sunlight directly into electricity through the photovoltaic effect. The panel 202 can include numerous photovoltaic cells, which can be made of silicon that will generate a direct current (DC) when exposed to sunlight. The cells are encapsulated in a protective layer that provides structure, but is transparent to enable exposure to sunlight. In some implementations, the panel encapsulation is glass, tempered glass, laminated glass, polycarbonate, or other material. Glass and glass-like materials are often very resistant to compressive forces, however they can be brittle, or sensitive to shear and/or tensile forces.

The frames 204 can be friction fitted (e.g., secured) onto the edges of the panel 202 and provide structural support for the panel. In general, the frames 204 create a border surrounding at least some of the edges of the panel 202 to enable mounting and provide a non-glass structure to enhance the overall strength and durability of the panel 202. In some implementations, the frames are formed of aluminum, steel, iron, metal alloy, polymer, or composite material. The frames 204 generally provide a rigid or semi-rigid structure to reinforce the panel 202 and provide mounting points to connect the panel 202 to other objects (e.g., rooftops, tracking tubes, vehicles, etc.). In the illustrated example, frame 204 has an “E” shaped cross-section, with an upper slot that interfaces with the panel 202, and a lower slot that can provide mounting points or other thing. In some implementations, the frame 204 has a “C” shaped cross-section, “T” shaped cross-section or other suitable cross-section. For example, the panel 202 can be affixed to a frame 204 using adhesive, bolts, friction, or a combination thereof. In some implementations, a portion of frame 204 includes holes, or attachment points for cable 210. For example, a hook or loop can be affixed to a bottom portion of the frame 204, or perforations can be drilled through frame 204 to enable coupling with the cable 210.

The bracket 206 can be sprung steel or other material, and can be affixed either directly to panel 202, or to a backing of panel 202 (not shown) using an adhesive 214 such as a silicone, tape, glue, epoxy, or other adhesive that may or may not have structural properties. In some implementations, the bracket 206 is not affixed to the panel but is retained to the panel by reaction forces induced by cables 210. In some implementations a rubber boot or pad, or other member is installed at the interface between the bracket 206 and the panel 202 to distribute force between the bracket 206 and the panel 202. In the illustrated example, the bracket includes a pair of arms 214 and is designed to fit over the torque tube 208. One or more surface features 212 of the torque tube can engage with the bracket 206, such that when the bracket 206 is pressed over the torque tube 208, it snaps, clicks, or is otherwise retained on the torque tube 208. The arms 214 can include teeth, one or more ridges, slots, holes, etc. which interface with the surface feature 212 of the torque tube. While illustrated as a protrusion, in some implementations surface feature 212 can be a hole, or a groove in the side of the torque tube 208 that the bracket 206 interfaces with. In general, the bracket 206 is capable of flexing when pressure is applied to move past the surface feature 212, and lock into place or engage with the torque tube once past.

In some implementations, the bracket 206 includes an electrical interface that provides an electrical connection between the panel 202 and the array output (e.g., combiner box 102 as described above with respect to FIG. 1). That is, the output of the panel 202 can be wired to contacts of connectors on the bracket, and when the bracket interfaces with the torque tube 208, an electrical connection is made with a wire or wires mounted to, or within the torque tube. 208. In this manner, during installation, technicians need only slot the panel and bracket onto the torque tube 208, without any further process to electrically connect the panel 202.

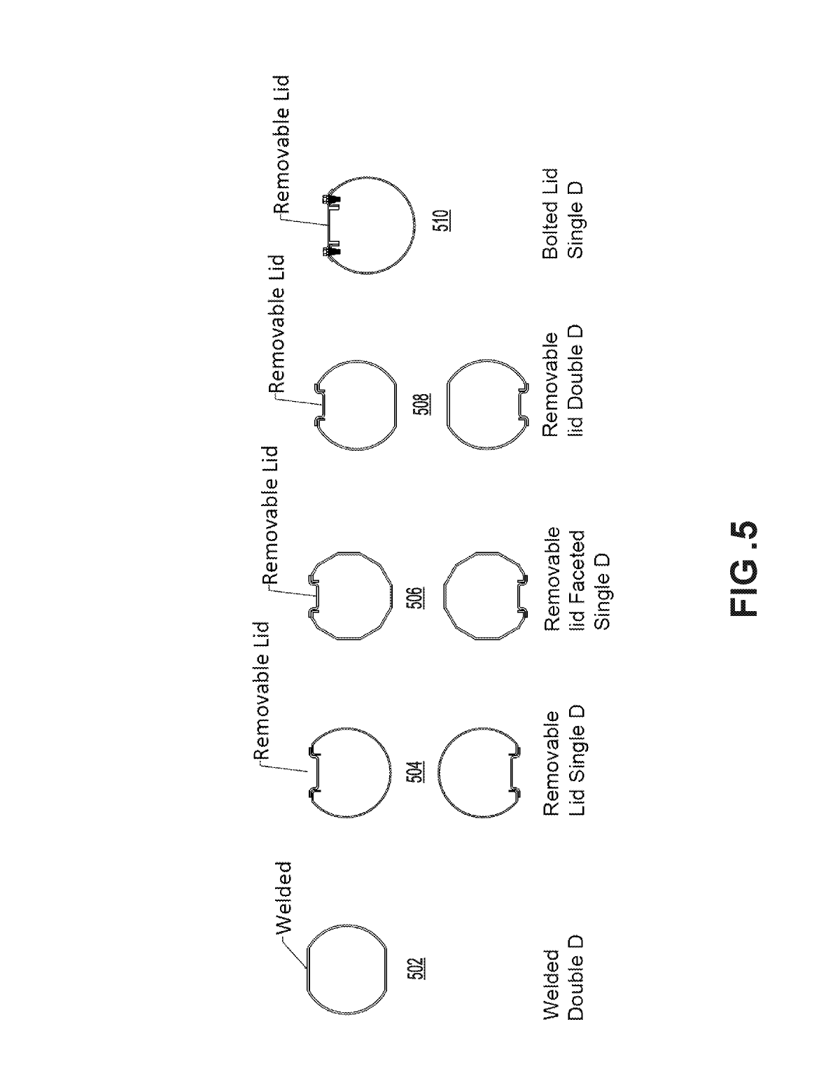

The torque tube 208 can be a structural tube on which the panel 202, or multiple panels 202 and their associated support structure are mounted. In some implementations, a tracking motor and bearings enable the torque tube 208 to rotate about its axis, and rotate the mounted panels 202 toward the sun. The torque tube 208 can be steel, iron, metal alloy, or other suitable material. While illustrated as having a square cross-section with rounded corners, the torque tube can be other shapes. For example, a round tube, oval shaped tube, perfect square, rectangle, trapezoid or other cross section are usable. Some alternative example torque tubes are illustrated below with respect to FIG. 5.

The cables 210 can be steel, nylon, fiber, or other suitable material, and generally are under tensile stress, pulling the frames 204 toward each other and the bracket 206 (e.g., toward the center of the panel to which the brackets are connected). By pulling the outer frames (parallel to the torque tube) 204 toward each other, the panel 202 is put under compressive stress, which can reinforce the panel 202, enabling it to withstand higher loads. Further, because there is an angle between the frames 204 and the bracket 206, the cables 210 form a truss, creating a relatively strong, yet lightweight, structure. In some implementations, the cables are affixed between the frame and bracket using hook and loop attachment points. For example, the ends of the cables 210 can include a loop that engages with a hook on the respective frame 204 or bracket 206. In some implementations, the cable is affixed using a ball and socket joint, or a ball configured to slide into a slot. Cable 210 can, in some instances include tensioning devices such as a jaw and jaw turnbuckle, rail tensioner, racket tensioner, or other mechanism. It should be noted that the illustrated dimensions and angles are not to scale and are for exemplary purposes only. In some implementations, instead of or in addition to cables, rods, shafts, connection brackets, or other tensions members can be used.

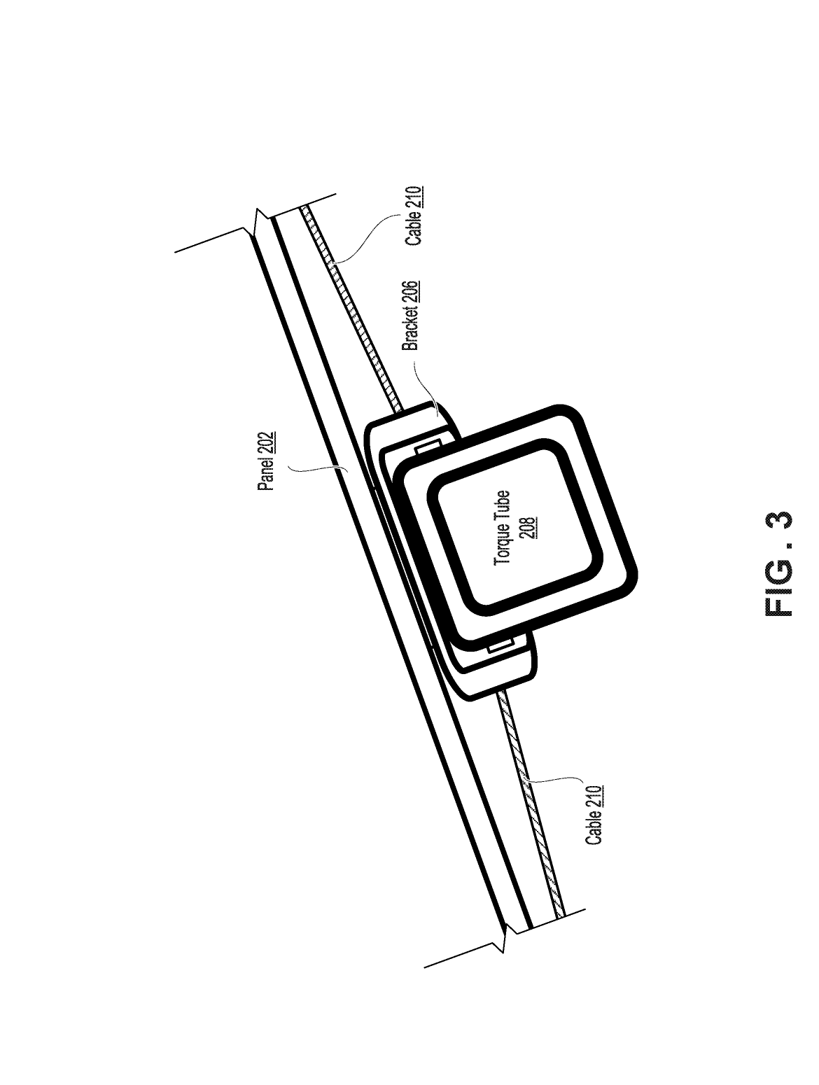

FIG. 3 illustrates a side assembled view of a truss mounting system. As can be seen, the angle between cables 210 and the panel 202 is created by affixing the cables 210 to a center or lower portion of bracket 206. While illustrated as partially covering torque tube 208, in some implementations, the bracket 206 can surround the torque tube on three sides, or fully encircle the torque tube 208. In some implementations, the bracket 206 can recess into, or mate with the torque tube 208.

The bracket 206 and cables 210 can be pre-installed on the panel 202 at a factory. In some implementations, the cables are tensioned to a specific tension amount. The cables 210 can be tensioned using a jaw and jaw turnbuckle, rail tensioner, racket tensioner, or other mechanism.

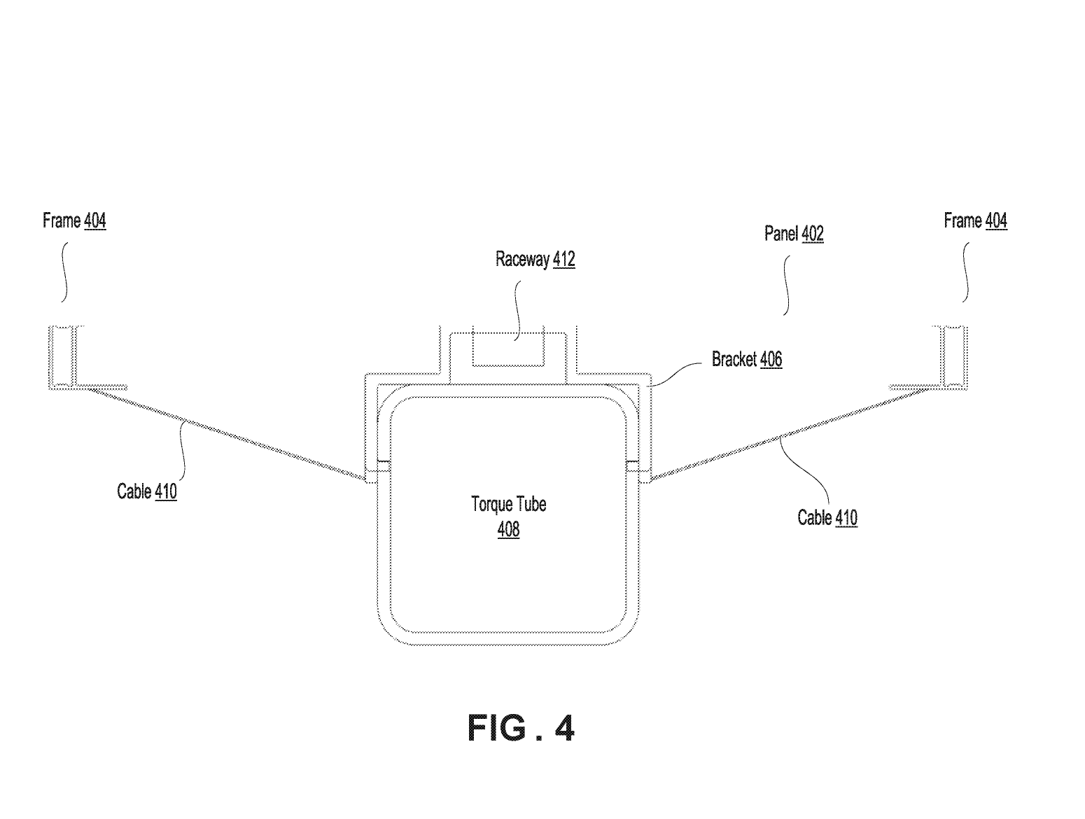

FIG. 4 illustrates a side, assembled view of a truss mounting system with an alternate bracket. The illustrated truss mounting system includes similar components as in FIGS. 2 and 3, with a panel 402, frame 404, cables 410, and torque tube 408. However, the bracket 406 shown has an alternative, stepped configuration. This configuration enables the panel 402 to be mounted further from the torque tube 408, increasing the angle between the cables 410 and the panel 402.

Within the stepped bracket 406, a raceway 412 can be provided, which can be used as a weathertight or semi-weathertight area in which cables can be routed and where electrical connections can be made. In some implementations the raceway 412 is used to route cables for an entire series connected string of panels along the top of torque tube 408.

FIG. 5 illustrates example alternative torque tube configurations. The illustrated configurations include a double D with welded caps (502), a removable lid single D (504), a removable lid faceted single D (506), a removable lid double D (508) and a bolted lid single D (510). It should be noted that these are example configurations and other configurations are possible (e.g., a bolted lid, faceted, double D).

The welded double D configuration (502) shows has a cross section with two curved surfaces and two flat surfaces. In some implementations this is a truncated circle or oval. Having flat surfaces provides mounting points for panels and rotating motors, while the overall curved cross-section can provide high strength relative to material usage.

The removable lid single D configuration (504) includes a removable lid. This lid can be friction fit, glued in, snapped in, etc. A removable lid can provide access to the interior volume of the torque tube, which can be used to route cables, electrical connectors, or other components. In some implementations, a bracket that is mounted to a solar panel (e.g., bracket 206 or 406 as described above with respect to FIGS. 2-4) can be used as both a lid, and a mounting point for a panel.

The faceted version (506) can be made from folded steel or extruded material (e.g. aluminum). Faceting, or providing an octagonal, hexagonal, or other shaped cross-section can enable easier mounting and manufacture.

The double D cross section (508) includes both a lid and a flat surface, which can provide a ready mounting point for interior components (e.g., cable raceways, connectors, fuses, etc.) and can further provide a surface feature for mounting brackets, rotator motors, or other components to the exterior.

A bolted removable lid (510) can be used in addition to or alternatively from any of the other lids illustrated in FIG. 5. The lid can be bolted over an opening using well nuts, nut and washer combinations, rivets, swaged fasteners (e.g., Huck bolts) or other system. In some implementations a seal (e.g., rubber or silicon gasket) is provided to prevent moisture from entering an interior of the torque tube.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

The foregoing description is provided in the context of one or more particular implementations. Various modifications, alterations, and permutations of the disclosed implementations can be made without departing from scope of the disclosure. Thus, the present disclosure is not intended to be limited only to the described or illustrated implementations but is to be accorded the widest scope consistent with the principles and features disclosed herein.

1. A mounting system comprising:
a frame configured to be affixed to an edge of a photovoltaic panel;
a bracket mounted to a surface of the photovoltaic panel, the bracket comprising a locking mechanism configured to interface with a surface feature; and
two or more tension members extending from the frame to the bracket configured to place a portion of the photovoltaic panel in compression.

2. The system of claim 1, wherein the surface feature is a surface feature on a torque tube, and wherein when interfaced, the bracket couples the photovoltaic panel to the torque tube.

3. The system of claim 2, wherein the bracket forms an electrical connection between an output of the photovoltaic panel and a conductor mounted to the torque tube.

4. The system of claim 1, wherein the bracket is mounted to the surface of the photovoltaic panel using an adhesive.

5. The system of claim 1, wherein the frame is friction fit to the edge of the photovoltaic panel.

6. The system of claim 1, wherein the two or more tension members are steel cables.

7. The system of claim 1, wherein the two or more tension members are tensioned to a predetermined tension.

8. A photovoltaic panel mounting system, comprising:
a frame member configured to engage an edge of a photovoltaic panel;
a bracket having a torque tube interface and a panel interface, wherein:
the torque tube interface is configured to secure the bracket to a torque tube;
the panel interface is configured to secure the bracket to a face of the photovoltaic panel;
the face of the photovoltaic panel is a surface of the photovoltaic panel that extends between the edge of the photovoltaic panel and an opposite edge of the photovoltaic panel; and
a tension member configured to connect to each of the frame member and the bracket.

9. The system of claim 8, wherein the torque tube interface is configured to interface with a surface feature on the torque tube.

10. The system of claim 9, wherein the bracket forms an electrical connection between an output of the photovoltaic panel and a conductor mounted to the torque tube.

11. The system of claim 8, wherein the panel interface secures the bracket to a face of the photovoltaic panel using an adhesive.

12. The system of claim 8, wherein the frame is friction fit to the edge of the photovoltaic panel.

13. The system of claim 8, wherein the tension member is a steel cable.

14. The system of claim 8, wherein the tension member is tensioned to a predetermined tension.
